(19) United States
(12) Patent Application Publication
(10) Pub. No.: US 2006/0152493 A1
(43) Pub. Date: Jul. 13, 2006

(54) Driving method of an internet radio hot key

(75) Inventors: Ben Yang, Lu Chou City (TW); Chin-Ping Wang, Hsintien City (TW); Motor Jso, Tu Cheng City (TW)

Correspondence Address: BIRCH STEWART KOLASCH & BIRCH, PO BOX 747, FALLS CHURCH, VA, 22040-0747, US

(73) Assignee: Lite-On Technology Corporation

(21) Appl. No.: 11/033,706

(22) Filed: Jan. 13, 2005

(51) Int. Cl. G09G 5/00

(52) U.S. Cl. 345/168

(57) ABSTRACT

A driving method for Internet radio hot key is described. The Internet radio function is incorporated as a hot key built into a conventional keyboard of a computer. A keyboard-driving program is installed in the operating system in a computer and used to monitor a key code generated when the hot key is pressed. A radio program is then launched to retrieve an audio stream from a Internet radio station, as pressing the hot key is a preferred embodiment of the present invention.

### BACKGROUND OF THE INVENTION

1. Field of the Invention

The present invention relates to a driving method for an Internet radio hot key, more particularly for when an Internet radio hot key is pressed, a radio program is activated to retrieve the Internet radio stream.

2. Description of Related Art

Conventionally, a user listens to radio program broadcasted from a radio station through a radio player. Interference from the environment, objects, or disturbance from surrounding electromagnetic sources often interfere with the sound quality of the radio, confining the broadcast range of the station to a limited region. Although a short wave radio can receive a short wave radio broadcast from far away, even from other countries in some cases, its sound quality is nevertheless affected.

Broadband radio has recently become more and more accessible and popular, so more and more Internet radio stations are being occupied. Therefore, users can listen to various radio programs from a variety of Internet radio stations from other countries over the Internet.

The method for listening to an Internet radio program comprises the following steps:

a computer connects to the Internet and its internal peripherals, such as speakers and a sound card, are prepared.

Then, Internet radio web sites are searched for by employing an Internet browser, such as Internet Explorer (IE), or Netscape. Then the computer connects to a URL, for example, http://www.icrt.com.tw, so the user can find the access point for downloading the sound stream (step S101).

The access point for the Internet radio link is clicked to download the radio stream (step S103).

After clicking the access point for the Internet radio link, a multimedia program for the radio stream, such as the Microsoft Windows Media Player or Real Player, is launched (step S105).

Next, the multimedia program retrieves the radio stream from the Internet radio station over the Internet (step S107).

Because more and more people are listening to Internet radio, many radio station sites and channels are built into multimedia programs. Users can easily choose from the multimedia program's preset list.

FIG. 2 shows one of the embodiments of the prior art.

First, the computer is turned on, and connected to the Internet. Then a multimedia radio program is executed (step S201).

A user can then choose one of the Internet radio stations from the multimedia radio program's database and listen to the radio program. Furthermore, the user can choose one of them based on the Internet bandwidth or other categories provided (step S203).

The radio stream is received after clicking the access point to the Internet radio station.

To overcome the prior situation in which some complicated steps are required to receive the Internet radio stream, or much time is spent searching for a radio stations, an Internet radio hot key installed on the keyboard is introduced. The key code of the hot key corresponds with a specific Internet radio station. Thereby, when the hot key is pressed, a corresponding predefined Internet station is activated to retrieve the Internet radio stream.

### SUMMARY OF THE DISCLOSURE

Broadly speaking, a driving method for Internet radio hot key is disclosed in the present invention and more particularly, an Internet radio hot key is disposed on a conventional keyboard. The Internet radio hot key can be defined as a new function while the radio hot key is activated. A user can listen to Internet radio over the Internet after pressing the Internet radio hot key.

The method for driving the Internet radio hot key comprises pressing an Internet radio hot key in the first step, and, when the key code of the hot key is transmitted, a keyboard-driving program intercepts the key code, and finally a radio program is activated to retrieve a radio data stream.

### BRIEF DESCRIPTION OF DRAWINGS

The present invention will be readily understood by the following detailed description in conjunction with the accompanying drawings, in which:

FIG. 1 is a flow chart illustrating the method for retrieving a radio stream over the Internet of the prior art;

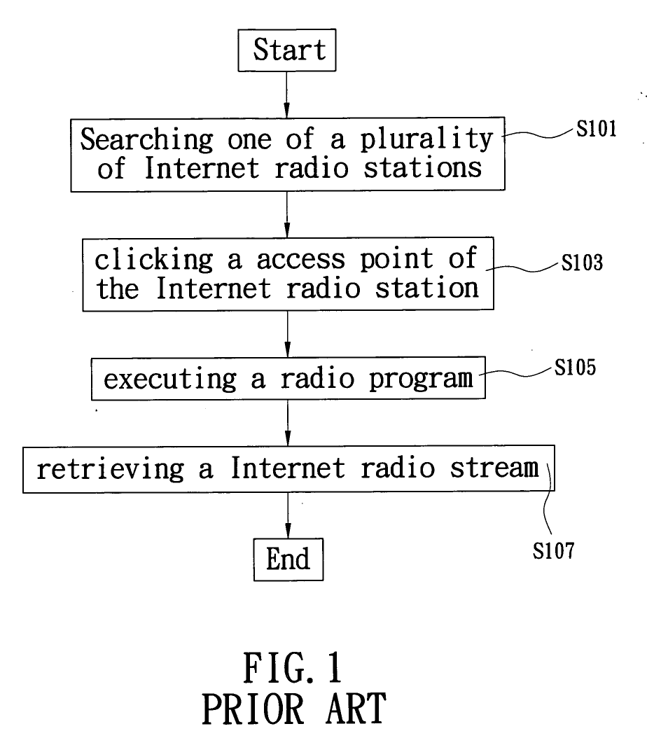

FIG. 2 is a flow chart of the method for using conventional radio software of the prior art;

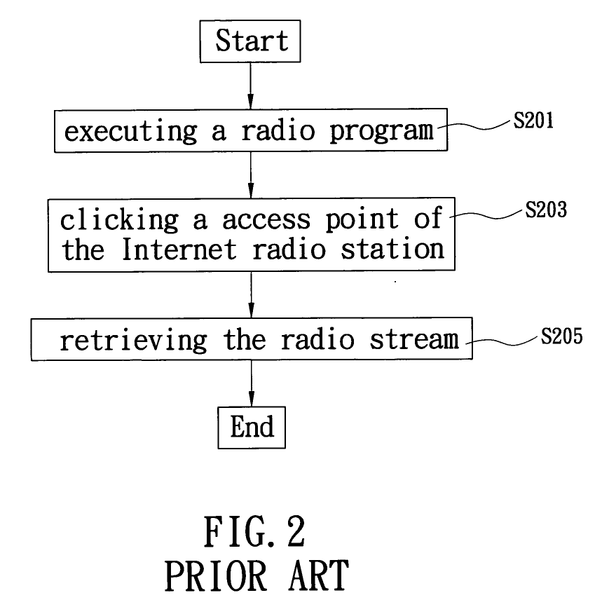

FIG. 3 is a schematic diagram showing the Internet radio hot key of the present invention;

FIG. 4 is a flow chart of the method for using the radio hot key of the present invention; and

FIG. 5 shows a flow chart of the driving method for the hot key of the present invention.

### DETAILED DESCRIPTION OF THE PREFERRED EMBODIMENTS

To allow the examiner to understand the technology, means and functions adopted in the present invention further, reference is made to the following detailed description and attached drawings. The examiner shall readily understand the invention deeply and concretely from the purpose, characteristics and specification of the present invention. Nevertheless, the present invention is not limited to the attached drawings and embodiments in following description.

For simplifying the steps for listening to the Internet radio, an Internet radio hot key is incorporated on a conventional keyboard. A hot key-driving program is preloaded or exists as a daemon in the operation system of a computer, and is used to configure the function of the Internet radio hot key. The Internet radio hot key can be employed to link to a predetermined Internet radio station.

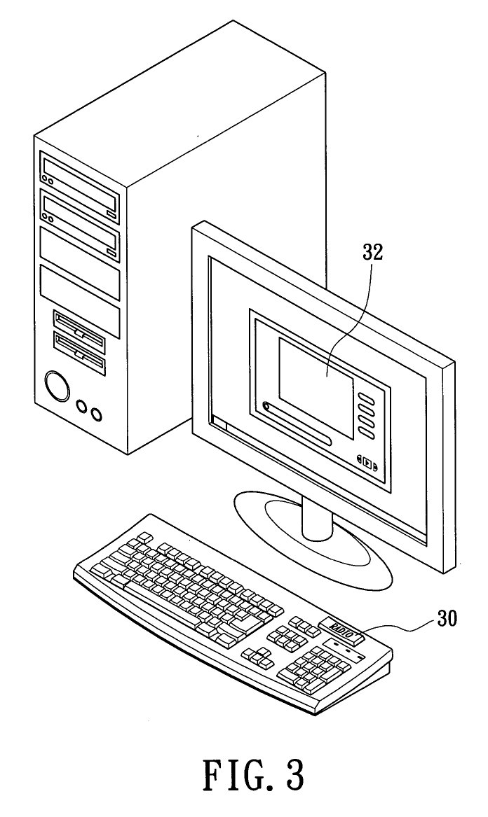

FIG. 3 shows a preferred embodiment of the present invention. An extra Internet radio hot key 30 is installed on a computer's keyboard. Moreover, a keyboard-driving program is installed or preloaded on the computer, or even built into the operating system therein. When a user presses the hot key 30, the Internet radio program 32 is activated to link to a predetermined Internet radio station, and download the radio data stream. Wherein, the Internet radio program can be a graphic-user-interface (GUI) 32 or processed in the background as the user listens to the Internet radio program.

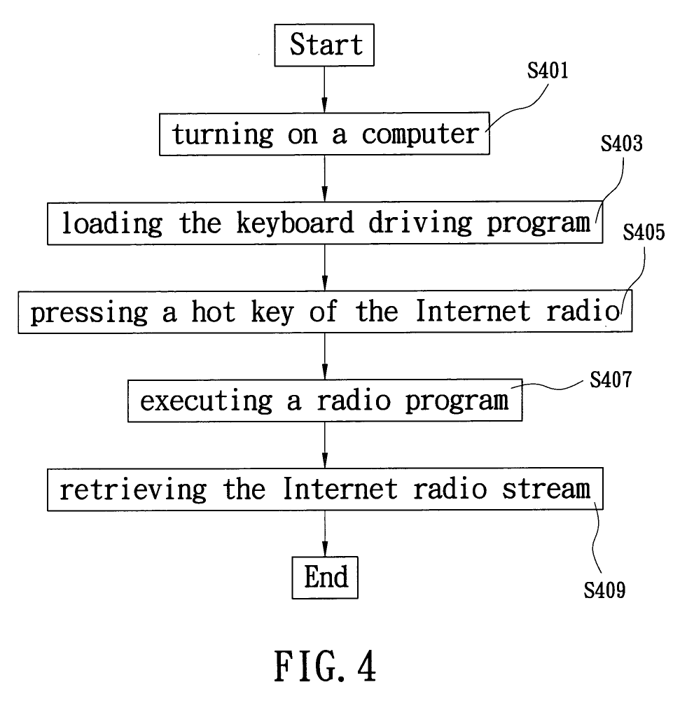

Reference is made to FIG. 4 showing the method for using the Internet radio hot key, comprising the steps:

A computer ready to link to the Internet is turned on, and a keyboard with an Internet radio hot key is provided.

The computer that can be linked to the Internet is ready (step S401). A keyboard-driving program is loaded onto the computer manually or by an auto executed procedure. More particularly, a program built into the operating system of the computer is one of the preferred embodiments (step S403).

After the Internet radio hot key is pressed (step S405), an Internet radio program, such as the Media Player, which already exists in the operating system, is activated (step S407). However, the Internet radio program can be a proprietary program of the present invention. Finally, the Internet radio program links to a predetermined Internet radio station and retrieves the Internet radio data stream (step S409).

As stated above, predetermined Internet radio stations are recorded in the. Moreover, one of the radio stations in the list can be a default Internet radio station, but can be changed by the user.

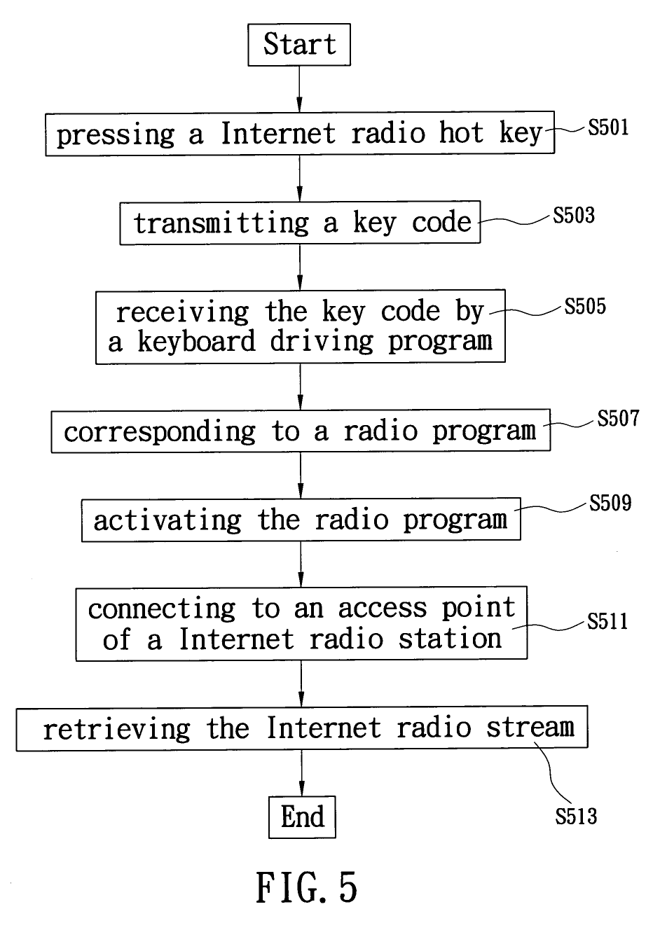

FIG. 5 shows the preferred embodiment of the present invention, which describes the driving method for the Internet radio hot key, comprising of the following steps:

The hot key is first pressed (step S501), and the keyboard controlled circuit transmits a key code defined as the Internet radio hot key, the key code stands for the physical position of the hot key on the keyboard, such as a scan code (step S503).

The keyboard-driving program loaded on the computer monitors and intercepts the key code of the hot key. The step of loading the driving program further includes the step of determining whether the Internet radio hot key has been pressed. If a key code is intercepted by the keyboard-driving program but does not originate from the Internet radio hot key, the key code can be ignored since that is from a regular key of the keyboard. Afterward, the other programs can take over the key code (step S505).

If the key, which is determined as the Internet radio hot key of the present invention, is intercepted by the keyboard-driving program, a corresponding radio program is introduced. The hot key and the corresponding Internet radio program employ/use a lookup table to store the user's preferences. Besides, the radio program can be a preloaded media player or a proprietary program of the present invention (step S507).

Next, the Internet radio program with various access points to Internet radio stations is activated after pressing the Internet radio hot key (step S509). The Internet radio program operatively links to one of the access points mentioned above, and the access point can be a default value, or predetermined by the user (step S511).

Finally, the Internet radio data stream is retrieved through the Internet radio program (step S513).

The present invention describes a driving method for an Internet radio hot key. Accordingly, a hot key is disposed on a conventional keyboard, and a proprietary keyboard-driving program is introduced to intercept the hot key code when the hot key is pressed. Next, a radio program is activated and downloads the Internet radio stream.

The invention may be embodied in other specific forms without departing from the sprit or essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A driving method for an Internet radio hot key, which is installed as an Internet radio hot key on a keyboard and used to connect to an Internet radio stream, comprising:
pressing said Internet radio hot key;
transmitting a key code of said Internet radio hot key;
intercepting said key code of said Internet radio hot key through a keyboard-driving program;
activating an Internet radio program; and
retrieving an Internet audio stream.

2. The method recited as in claim 1, wherein said keyboard driving program is installed manually.

3. The method recited as in claim 1, wherein said keyboard-driving program is installed by an auto executed procedure.

4. The method recited as in claim 1, wherein said keyboard-driving program is built into an operating system of a computer.

5. The method recited as in claim 1, wherein said Internet radio program is a media-playing program pre-installed in the operating system of the computer, or a proprietary program thereof.

6. The method recited as in claim 1, wherein said Internet radio program contains a plurality of Internet radio station access points.

7. The method recited as in claim 1, wherein the step of intercepting said key code includes a step of determining whether said key code is from said Internet radio hot key or not.

8. The method recited as in claim 1, wherein the step of activating said radio program corresponds to said key code of said hot key with said Internet radio program referring to a lookup table therewith.
